(19) United States
(12) Patent Application Publication
(10) Pub. No.: US 2013/0342798 A1
(43) Pub. Date: Dec. 26, 2013

(54) LIQUID CRYSTAL DISPLAY PANEL, LIQUID CRYSTAL DISPLAY APPARATUS, AND LIQUID CRYSTAL DISPLAY CELL

(71) Applicants: Isamu Miyake, Osaka-shi (JP); Koichi Miyachi, Osaka-shi (JP)

(72) Inventors: Isamu Miyake, Osaka-shi (JP); Koichi Miyachi, Osaka-shi (JP)

(73) Assignee: SHARP KABUSHIKI KAISHA, Osaka-shi, Osaka (JP)

(21) Appl. No.: 14/003,587

(22) PCT Filed: Mar. 2, 2012
(86) PCT No.: PCT/JP2012/055463

§ 371 Date: Sep. 6, 2013

(30) Foreign Application Priority Data
Mar. 9, 2011 (JP) 2011-051532

(51) Int. Cl. G02F 1/1337

(52) U.S. Cl. CPC G02F 1/133788
USPC 349/132; 349/123

(57) ABSTRACT

There are provided a liquid crystal display panel and a liquid crystal display apparatus which have high display quality and in which thready defects generated in a display pixel are suppressed. In the liquid crystal display panel, at least one of a pair of substrates includes a photo-alignment film and an electrode, and a liquid crystal layer contains liquid crystal molecules whose elastic constant K1 concerning splay deformation and/or elastic constant K3 concerning bend deformation is 13 pN or more at 20° C.

### TECHNICAL FIELD

The present invention relates to a liquid crystal display panel, a liquid crystal display apparatus, and a liquid crystal display cell. More specifically, the present invention relates to a liquid crystal display panel, a liquid crystal display apparatus, and a liquid crystal display cell in which a horizontal photo-alignment film is formed.

### BACKGROUND ART

Liquid crystal display apparatuses have strong points such as a slim type, light weight, and low power consumption and thus have been widely used for mobile applications, monitors, large-screen televisions, and the like. In such fields, various characteristics have been required and various display modes have been developed. The basic structure and principle of liquid crystal display apparatuses are as follows. A liquid crystal display apparatus includes a pair of substrates that sandwich a liquid crystal layer. A certain voltage is applied to an electrode that is disposed on the substrate on the liquid crystal layer side to control the alignment direction of liquid crystal molecules contained in the liquid crystal layer. Thus, the transmission/blocking of light (on/off of display) is controlled, which allows liquid crystal display.

Examples of the recently used display modes of liquid crystal display apparatuses include a vertical alignment (VA) mode in which liquid crystal molecules having negative dielectric anisotropy are vertically aligned with respect to a substrate surface, and an in-plane switching (IPS) mode and a fringe field switching (FFS) mode in which liquid crystal molecules having positive or negative dielectric anisotropy are horizontally aligned with respect to a substrate surface and a transverse electric field is applied to a liquid crystal layer.

Alignment stabilization with a polymer (hereinafter also referred to as “polymer sustained (PS) process”) has been proposed as a method for producing a high-luminance and fast-response liquid crystal display apparatus (e.g., refer to PTLs 1 to 8). In a pretilt-angle-providing technique with a polymer (hereinafter also referred to as “polymer sustained alignment (PSA) technique”), a liquid crystal composition prepared by mixing polymerizable components such as a polymerizable monomer and a polymerizable oligomer is sealed between substrates. The monomer is polymerized while liquid crystal molecules are tilted by applying a voltage between the substrates and thus a polymer is formed. This provides liquid crystal molecules tilted at a particular pretilt angle even after the removal of the voltage application, and the alignment direction of the liquid crystal molecules can be specified to a certain direction. The monomer to be formed into the polymer is a material polymerized by heat, light (ultraviolet light), or the like.

### CITATION LIST

### Patent Literature

PTL 1: Japanese Patent No. 4175826
PTL 2: Japanese Patent No. 4237977
PTL 3: Japanese Unexamined Patent Application Publication No. 2005-181582
PTL 4: Japanese Unexamined Patent Application Publication No. 2004-286984
PTL 5: Japanese Unexamined Patent Application Publication No. 2009-102639
PTL 6: Japanese Unexamined Patent Application Publication No. 2009-132718
PTL 7: Japanese Unexamined Patent Application Publication No. 2010-33093
PTL 8: U.S. Pat. No. 6,177,972

### Non Patent Literature

NPL 1: M. KIMURA, “17th Experimental Lecture on Liquid Crystal Science Measurements of Surface Anchoring Energy No. 3”, Liquid Crystal, The Japanese Liquid Crystal Society, published on Jan. 25, 2006, Vol. 10, No. 1, pp. 95-101

### SUMMARY OF INVENTION

### Technical Problem

The inventors of the present invention are studying a photo-alignment technique in which the liquid crystal alignment during the voltage application can be controlled in multiple directions without performing a rubbing treatment on an alignment film and thus good viewing angle characteristics can be achieved. The photo-alignment technique is a technique in which a photoactive material is used as a material for alignment films and the formed film is irradiated with light such as ultraviolet light to provide an alignment regulating force to the alignment film. By employing this photo-alignment technique, an alignment treatment can be performed on the film surface in a non-contact manner, which can suppress the generation of, for example, dirt and dust during the alignment treatment. The photo-alignment technique can be appropriately applied to a large-size panel unlike a rubbing treatment, and furthermore achieves a high production yield.

A current photo-alignment technique is mainly introduced for the mass production of televisions that use a vertical alignment film in a VA mode or the like, but is not yet introduced for the mass production of televisions that use a horizontal alignment film in an IPS mode or the like. This is because severe image sticking is formed on a liquid crystal display by using such a horizontal alignment film. The image sticking is a phenomenon in which, when a constant voltage is continuously applied to a liquid crystal cell for a certain time, the brightness of a portion to which the voltage has been continuously applied is different from the brightness of a portion to which the voltage is not applied.

The inventors of the present invention have already found that the formation of a stable polymer layer by a PS process is suitable for the purpose of suppressing the image sticking due to weak anchoring of the horizontal photo-alignment film. To achieve this, it is important to facilitate the polymerization reaction for the PS process. As specifically described in Japanese Patent Application No. 2010-231924, the combination of a particular liquid crystal component and the PS process is suitable. This increases the formation rate of the polymer layer (the rate at which the polymer layer is formed through deposition on a surface of the alignment film on the liquid crystal layer side after the chain polymerization such as radical polymerization of a polymerizable monomer in the liquid crystal layer has been started), and thus a polymer layer (PS layer) having a stable alignment regulating force can be formed. When the alignment film is a horizontal alignment film, the rate of the polymerization reaction and the formation rate of the polymer layer can be increased and thus a particularly large effect of suppressing image sticking is realized.

In liquid crystal display modes such as an IPS mode, an FFS mode, an OCB mode, a TN mode, and an STN mode that use a horizontal photo-alignment film, the generation of thready defects is particularly problematic among alignment defects caused by weak anchoring of the horizontal photo-alignment film. The thready defects are thready alignment defects of liquid crystal, which causes light leakage. The thready defects affect the quality of liquid crystal display apparatuses in such a manner that deep black is not achieved, which degrades the contrast, and at the same time grainy display is caused. In PTLs 1 to 8, there are no descriptions concerning the horizontal photo-alignment film and there are also no descriptions concerning the generation of thready defects caused by weak anchoring. In NPL 1, the alignment deformation caused by weak anchoring is described, but there are no descriptions concerning the photo-alignment film. Furthermore, an effect of stabilizing alignment deformation when a spacer is present is not discussed.

The importance of suppressing thready defects particularly becomes noticeable when a liquid crystal display apparatus that uses a horizontal photo-alignment film having a weak alignment regulating force is mass-produced. This is believed to be a new problem in the technical field involving the present invention.

In view of the foregoing, it is an object of the present invention to provide a liquid crystal display panel, a liquid crystal display apparatus, and a liquid crystal display cell which have high display quality and in which thready defects generated in a display pixel are suppressed.

### Solution to Problem

As a result of thorough studies conducted by the inventors of the present invention, they have found that there are three causes for the generation of such thready defects. The first cause is the case where the alignment film itself has weak anchoring. The inventors of the present invention have found that weak anchoring of an alignment film decreases the alignment regulating force and consequently liquid crystal molecules in a bulk easily deviate from the alignment treatment direction of the alignment film. A method in which the anchoring strength of the alignment film itself is increased is considered to be employed to overcome the problem. However, the horizontal photo-alignment film generally has a considerably low anchoring energy compared with the horizontal alignment film for rubbing. Therefore, an approach to improve the characteristics of a horizontal photo-alignment film material is difficult. The second cause is the case where the elastic constant of liquid crystal is small. The inventors of the present invention have found that, when the elastic constant is small, liquid crystal molecules are easily subjected to elastic deformation, which easily causes the alignment disturbance. The third cause is the presence of spacers. The inventors of the present invention have found that spacers are always present at the starting end and terminal end of thready defects. Furthermore, for example, even if thready defects are generated at the moment when the phase transition from an isotropic phase to a liquid crystal phase occurs, the thready defects are not stable because of their elastic deformation energy in a region where the spacers are not present and it is observed that the thready defects disappear over finite time. That is, since spacers have an effect of stabilizing thready defects, a method for destabilizing the thready defects has been studied.

The inventors of the present invention have found an improvement method. As a result of the detailed analysis of the liquid crystal alignment of thready defects with a polarizing microscope, it has been found that the liquid crystal deformation is mainly constituted by splay and bend. Splay deformation, bend deformation, or both the deformations are dominant at both ends of each of thready defects, that is, around the spacers such as beads. Both the splay deformation and bend deformation are dominant in an intermediate portion of each of thready defects. Therefore, an increase in the alignment deformation energy leads to the destabilization of the thready defects, and thus it is important to increase the elastic constants K1 (splay) and K3 (bend) of liquid crystal. Since thready defects are not formed by only splay deformation or only bend deformation, an increase in one of the elastic constants K1 and K3 sufficiently produces an effect of suppressing thready defects. Accordingly, the inventors of the present invention have conceived that the above problem can be overcome and have completed the present invention.

The present invention provides a liquid crystal display panel including a pair of substrates and a liquid crystal layer sandwiched between the pair of substrates, wherein at least one of the pair of substrates includes a photo-alignment film and an electrode in that order from the liquid crystal layer side, and the liquid crystal layer contains liquid crystal molecules whose elastic constant K1 concerning splay deformation and/or elastic constant K3 concerning bend deformation is 13 pN or more at 20° C. Hereafter, a horizontal photo-alignment film is mainly described as the photo-alignment film. The photo-alignment film in the present invention is preferably a photo-alignment film that aligns the liquid crystal molecules in a horizontal direction with respect to a main surface of the substrate (such a photo-alignment film that aligns liquid crystal molecules in a horizontal direction is referred to as “a horizontal photo-alignment film” in this description), but the advantageous effects of the present invention can be achieved by using the photo-alignment film. In the alignment of liquid crystal molecules in a horizontal direction with respect to a main surface of the substrate, the liquid crystal molecules are not necessarily aligned in a horizontal direction in a strict manner and may be aligned in a horizontal direction to the extent that an intended display can be realized in each mode of liquid crystal display apparatuses.

The elastic constant K1 concerning splay deformation and the elastic constant K3 concerning bend deformation are each preferably 13 pN or more at 20° C. This increases the energy required to form thready defects, and thus the advantageous effects of the present invention that suppresses thready defects can be further provided. In this description, the elastic constants K1 and K3 are values at 20° C. unless otherwise specified.

The preferred upper limit of K1 is 20 pN. The preferred upper limit of K3 is 20 pN.

The elastic constant K1 concerning splay deformation and/or the elastic constant K3 concerning bend deformation can be measured with Model EC-1 manufactured by TOYO Corporation. The measurement temperature is 20° C. In general, the liquid crystal molecules according to the present invention can be industrially produced by a typical chemical method. Those skilled in the art can easily prepare a liquid crystal material with a high elastic constant according to the present invention. By using a large amount of liquid crystal molecules having a K1 and/or K3 of more than 13 pN among many types of developed liquid crystal molecules and by mixing many types of liquid crystal molecules to set the physical values such as Δn, Δ∈, ∈, γ1, and Tni to be desired values, a liquid crystal for displays that satisfies all the physical values rather than only the elastic constants can be developed.

In the present invention, the liquid crystal molecules contained in the liquid crystal layer may be a mixture of multiple types of liquid crystal molecules. The liquid crystal layer may be composed of a mixture of multiple types of liquid crystal molecules in order to achieve at least one of ensuring of reliability, improvement in response speed, and adjustments of a liquid crystal phase temperature range, other elastic constants, dielectric anisotropy, and refractive index anisotropy. In the case where the liquid crystal molecules contained in the liquid crystal layer are a mixture of multiple types of liquid crystal molecules, the liquid crystal molecules as a whole need to satisfy the above-described elastic constants of the present invention. The liquid crystal molecules contained in the liquid crystal layer may be liquid crystal molecules having positive dielectric anisotropy (positive type) or liquid crystal molecules having negative dielectric anisotropy (negative type).

In an embodiment of the present invention, at least one of the pair of substrates of the liquid crystal display panel includes a polymer layer, a horizontal photo-alignment film, and an electrode in that order from the liquid crystal layer side. Another layer may be disposed between the polymer layer and the horizontal photo-alignment film and/or between the horizontal photo-alignment film and the electrode. For example, in at least one of the pair of substrates, the polymer layer is preferably formed between the liquid crystal layer and the photo-alignment film in the liquid crystal display panel. The other layer may be disposed between the polymer layer and the horizontal photo-alignment film and/or between the horizontal photo-alignment film and the electrode as long as the advantageous effects of the present invention are provided, but the polymer layer and the horizontal photo-alignment film are normally in contact with each other. Both the pair of substrates preferably include the horizontal photo-alignment film and the polymer layer. Furthermore, at least one of the pair of substrates preferably contains a linear electrode. In the liquid crystal display panel including the polymer layer formed as described above, the liquid crystal layer particularly preferably contains liquid crystal molecules having an alkenyl group.

The formation of the polymer layer is one of preferred embodiments, but is obviously not only one method in which the image sticking of the horizontal photo-alignment film is overcome. If the image sticking can be suppressed by another method (e.g., driving method), the formation of the polymer layer is not essential.

The horizontal photo-alignment film is a polymer film that exhibits anisotropy through irradiation with polarized light or non-polarized light and that has a characteristic of exerting an alignment regulating force on liquid crystal in a horizontal direction with respect to a main surface of the substrate. More preferably, the horizontal photo-alignment film is a photo-alignment film subjected to a photo-alignment treatment through the irradiation with ultraviolet light, visible light, or both. The pretilt angle provided to the liquid crystal molecules by the photo-alignment film can be controlled by adjusting, for example, the types of light, the irradiation time of light, the irradiation intensity of light, and the types of photo-functional groups. The pretilt angle of the horizontal photo-alignment film is preferably 0° to 45°, more preferably 0° to 10°, and further preferably 0° to 5°. In the IPS mode or FFS mode, the viewing angle characteristics are improved as the pretilt angle approaches 0°.

Since the formation of the polymer layer fixes the alignment, there is no need to prevent ultraviolet light or visible light from entering the liquid crystal layer after the production process, which gives broad options to the production process.

The horizontal photo-alignment film material may be a single polymer or a mixture containing different molecules as long as the horizontal photo-alignment film has the above-described characteristics. For example, a polymer having a functional group that allows photo-alignment may contain another low-molecular-weight compound such as an additive and another photo-inactive polymer. The horizontal photo-alignment film material is selected from materials that cause a photolysis reaction, a photoisomerization reaction, or a photodimerization reaction. That is, the photo-alignment film preferably contains at least one structure selected from the group consisting of a photoisomerized structure of a photo-functional group, a photodimerized structure of a photo-functional group, and a photolyzed structure of a photo-functional group. The photoisomerized structure of a photo-functional group is a structure in which a photo-functional group is isomerized by irradiation with light. For example, the photoisomerized structure is a structure in which a photo-functional group of a cis isomer (or a trans isomer) is converted into a photo-functional group of a trans isomer (a cis isomer) through the excited state by irradiation with light. The photodimerized structure of a photo-functional group is a structure in which photo-functional groups are bonded to each other by irradiation with light and the photo-functional groups are preferably formed by a cross-linking reaction which is a dimerization reaction. The photolyzed structure of a photo-functional group is a structure in which a photo-functional group is photolyzed by irradiation with light. Typical examples of the material that causes the photoisomerization reaction or the photodimerization reaction include azobenzene derivatives, cinnamoyl derivatives, chalcone derivatives, cinnamate derivatives, coumarin derivatives, diarylethene derivatives, stilbene derivatives, and anthracene derivatives. The photoisomerization material or the photodimerization material is preferably a cinnamate group or the derivative thereof. For example, the photo-alignment film is preferably composed of a cinnamate derivative. The benzene ring contained in such a functional group may be a heterocycle. Typical examples of the material that causes the photolysis reaction include polyimides containing a cyclobutane skeleton, polyamic acid, and siloxane materials.

The horizontal photo-alignment film is preferably a film (horizontal alignment film) that horizontally aligns liquid crystal molecules with respect to a main surface of the substrate. The horizontal alignment film may be a film that aligns at least liquid crystal molecules that come close to the horizontal alignment film in a substantially horizontal direction with respect to the surface of the photo-alignment film. The pretilt angle of the horizontal photo-alignment film is preferably 0° to 45°, more preferably 0° to 10°, and further preferably 0° to 5°. In the IPS mode or FFS mode, the viewing angle characteristics are improved as the pretilt angle approaches 0°. When the horizontal photo-alignment film is irradiated with light, the transfer of excitation energy from the alignment film to the monomer occurs more efficiently in the horizontal alignment film than in the vertical alignment film. Thus, for example, a more stable PS layer can be formed.

The horizontal photo-alignment film may be a photo-alignment film irradiated with ultraviolet light from the outside of the liquid crystal cell. In this case, when the horizontal photo-alignment film is formed through a photo-alignment treatment and the polymer layer is formed by photopolymerization, the horizontal photo-alignment film and the polymer layer are preferably formed at the same time using the same light. Thus, a liquid crystal display panel can be produced with high production efficiency.

The polymer layer in the present invention is preferably formed by polymerizing the monomer added to the liquid crystal layer, that is, the polymer layer is preferably the above-described PS layer. The PS layer normally controls the alignment of liquid crystal molecules that come close to the PS layer. The polymerizable functional group of the monomer is preferably at least one selected from the group consisting of an acrylate group, a methacrylate group, a vinyl group, a vinyloxy group, and an epoxy group. Among them, the polymer layer is preferably formed by polymerizing a monomer having an acrylate group or a methacrylate group. The monomer is preferably a monomer that initiates a polymerization reaction (photopolymerization) by irradiation with light or a monomer that initiates a polymerization reaction (thermal polymerization) by application of heat. In other words, the polymer layer is preferably formed by photopolymerization or thermal polymerization. The photopolymerization is particularly preferred and, in this case, the polymerization reaction can be easily initiated at room temperature. The light used in the photopolymerization is preferably ultraviolet light, visible light, or both.

In the present invention, the polymerization reaction for forming the PS layer is not particularly limited, and may be a successive polymerization in which bifunctional monomers are polymerized in stages while forming new bonds or a chain polymerization in which monomers bond to active species generated from a small amount of catalysis (initiator) one after another and the growth occurs in a chain manner. Examples of the successive polymerization include polycondensation and polyaddition. Examples of the chain polymerization include radical polymerization and ionic polymerization (e.g., anionic polymerization and cationic polymerization).

The polymer layer is formed on the horizontal photo-alignment film subjected to an alignment treatment, whereby the alignment regulating force of the alignment film is improved and the generation of image sticking on display can be suppressed. In the case where the monomer is polymerized to form a polymer layer while liquid crystal molecules are aligned at a pretilt angle by applying a voltage higher than or equal to the threshold voltage to the liquid crystal layer, the polymer layer is formed so as to have a structure that aligns the liquid crystal molecules at a pretilt angle.

The liquid crystal display panel of the present invention includes a spacer, and the spacer may be covered with the horizontal photo-alignment film. The phrase “the spacer may be covered with the horizontal photo-alignment film” means that at least a portion (normally a side portion) of the spacer that is in contact with the liquid crystal layer is covered with the horizontal photo-alignment film. For example, the spacer can be covered with the photo-alignment film by performing a coating process of the photo-alignment film on a substrate on which a spacer has been formed in advance or a substrate on which a spacer is disposed by spraying or the like. The spacer that has been formed on the substrate in advance is normally composed of resin. The spacer disposed by spraying or the like is normally composed of glass or plastic. The spacer is preferably a spacer that has been formed on the substrate in advance and is composed of resin. The resin is more preferably an acrylic resin. Examples of the shape of the spacer include a column, a prism, a frustum, and a sphere.

The pair of substrates included in the liquid crystal display panel of the present invention are substrates for sandwiching the liquid crystal layer. The pair of substrates are each formed by using, as a base, an insulating substrate composed of glass, resin, or the like and fabricating, for example, a wiring line, an electrode, and a color filter on the insulating substrate.

The alignment mode of the liquid crystal layer is preferably a mode that allows the use of a horizontal alignment film. Preferred examples of the alignment mode include an in-plane switching (IPS) mode, a fringe field switching (FFS) mode, an optically compensated birefringence (OCB) mode, a twisted nematic (TN) mode, a super twisted nematic (STN) mode, a ferroelectrics liquid crystal (FLC) mode, a polymer dispersed liquid crystal (PDLC) mode, and a polymer network liquid crystal (PNLC) mode. Among them, an IPS mode or an FFS mode is particularly preferred. The above alignment mode is also suitably a blue phase mode that does not require the formation of an alignment film. Furthermore, the above alignment mode is also suitable for the form in which a multi-domain structure is formed on at least one of the pair of substrates for the purpose of improving the viewing angle characteristics. The multi-domain structure is a structure including a plurality of alignment forms (e.g., a bend direction in an OCB mode or a twisting direction in a TN or STN mode) of liquid crystal molecules or a plurality of regions having different alignment directions of liquid crystal molecules during no voltage application, during voltage application, or during both no voltage application and voltage application. To achieve the multi-domain structure, an electrode needs to be patterned into an appropriate form, the alignment direction of the horizontal photo-alignment film needs to be patterned using a photo mask or the like when the horizontal photo-alignment film is irradiated with light, or both the patterning treatments need to be performed in an active manner.

As described above, the present invention can be suitably applied to, for example, an IPS or FFS mode display apparatus having good viewing angle characteristics. A technique that achieves good viewing angle characteristics is demanded for the applications of monitors for medical use, electronic books, smart phones, and tablet terminals.

The present invention also provides a liquid crystal display apparatus including the liquid crystal display panel of the present invention. A preferred embodiment of the liquid crystal display panel included in the liquid crystal display apparatus is the same as the preferred embodiment of the liquid crystal display panel of the present invention. It is one of the preferred embodiments of the present invention that the liquid crystal display apparatus of the present invention is an IPS mode liquid crystal display apparatus. It is also one of the preferred embodiments of the present invention that the liquid crystal display apparatus of the present invention is an FFS mode liquid crystal display apparatus. The IPS mode liquid crystal display apparatus is normally a transverse electric field liquid crystal display apparatus in which two types of electrodes are disposed on one of the pair of substrates so as to face each other when a main surface of the substrate is viewed in plan. The FFS mode liquid crystal display apparatus is normally a fringe field liquid crystal display apparatus in which a sheet electrode and a slit electrode disposed as another layer with an insulating layer formed between the slit electrode and the sheet electrode are disposed on one of the pair of substrates. Both the liquid crystal display apparatuses will be further described in detail in embodiments below.

The present invention also provides a liquid crystal display cell including a pair of substrates and a liquid crystal layer sandwiched between the pair of substrates, wherein at least one of the pair of substrates includes a photo-alignment film and an electrode in that order from the liquid crystal layer side, and the liquid crystal layer contains liquid crystal molecules whose elastic constant K1 concerning splay deformation and/or elastic constant K3 concerning bend deformation is 13 pN or more at 20° C. The liquid crystal display cell of the present invention includes the same constituent members as those of the liquid crystal display panel of the present invention, and the preferred constituent members are also the same as those of the liquid crystal display panel of the present invention. For example, the above photo-alignment film is preferably a photo-alignment film that aligns liquid crystal molecules in a horizontal direction with respect to a main surface of the substrate. In the liquid crystal display cell, the substrate on the viewing screen side is generally composed of blank glass.

The structures of the liquid crystal display panel and liquid crystal display apparatus of the present invention are not particularly limited by other constituent elements as long as the liquid crystal display panel and liquid crystal display apparatus are formed using the above constituent elements as essential elements. Other structures generally used in liquid crystal display panels and liquid crystal display apparatuses can be suitably applied.

The above embodiments may be appropriately combined with each other without departing from the scope of the present invention.

### Advantageous Effects of Invention

According to the present invention, there can be provided a liquid crystal display panel and a liquid crystal display apparatus which have high display quality and in which thready defects generated in a display pixel are suppressed. When the present invention is applied to, for example, an IPS or FFS mode liquid crystal display apparatus including a horizontal photo-alignment film, good viewing angle characteristics achieved by the horizontal photo-alignment film and an effect of suppressing thready defects can be provided.

### BRIEF DESCRIPTION OF DRAWINGS

FIG. 1 is a schematic sectional view showing an embodiment of a liquid crystal display cell according to a first embodiment.

FIG. 2 is a schematic plan view showing an interdigital electrode according to the first embodiment.

FIG. 3 is a photograph showing a display portion of the liquid crystal display cell according to the first embodiment.

FIG. 4 is a photograph showing a display portion of the liquid crystal display cell according to a second embodiment.

FIG. 5 is a schematic sectional view showing a liquid crystal display panel according to a third embodiment.

FIG. 6 is a schematic plan view showing an electrode having slits according to the third embodiment.

FIG. 7 is a schematic plan view showing a counter substrate according to the third embodiment.

FIG. 8 is a photograph showing a display portion of the liquid crystal display panel according to the third embodiment.

FIG. 9 is a photograph showing a display portion of the liquid crystal display panel according to a fourth embodiment.

FIG. 10 is a photograph showing a display portion of the liquid crystal display panel according to a fifth embodiment.

FIG. 11 is a photograph showing a display portion of the liquid crystal display cell according to Comparative Example 1.

FIG. 12 is a photograph showing a display portion of the liquid crystal display panel according to Comparative Example 2.

FIG. 13 is a photograph showing thready defects.

FIG. 14 is a photograph showing thready defects.

FIG. 15 shows an example of the alignment state of liquid crystal molecules in a region where thready defects occur.

FIG. 16 is a photograph showing a display portion of the liquid crystal display cell according to Comparative Example 3.

FIG. 17 is a photograph showing a display portion of the liquid crystal display panel according to Comparative Example 4.

### DESCRIPTION OF EMBODIMENTS

The present invention will now be further described in detail on the basis of embodiments below with reference to the attached drawings, but the present invention is not limited to these embodiments. In this description, a liquid crystal cell is a portion driven in a liquid crystal layer, such as a portion sandwiched between both substrates. In this description, the terms “or more” and “or less” are inclusive terms. In other words, the term “or more” means “not less than” (a value and values more than the value).

### First Embodiment

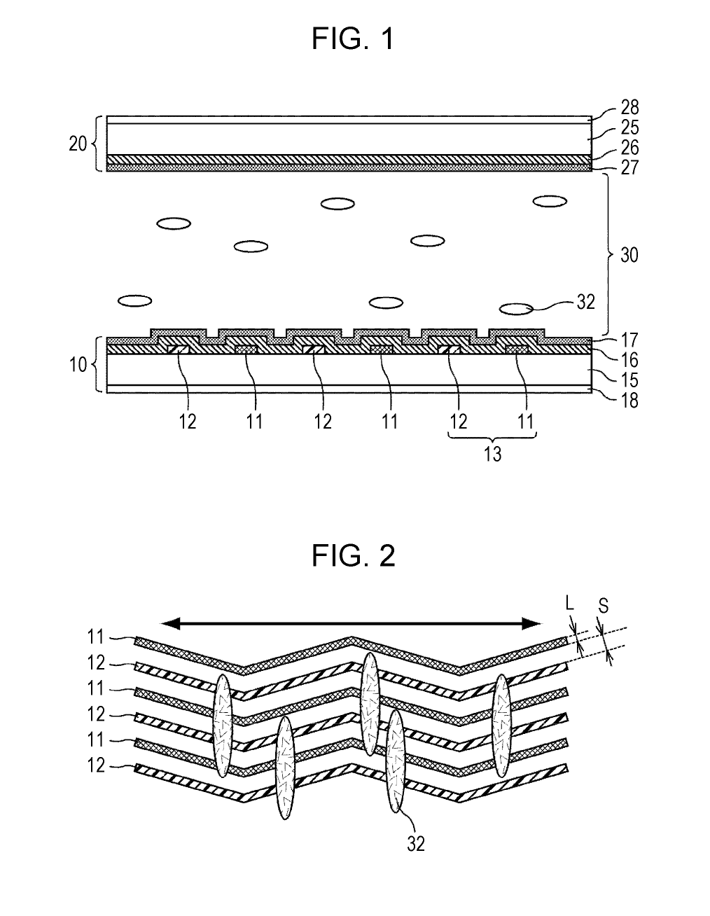

FIG. 1 is a schematic sectional view showing an embodiment of a liquid crystal display cell according to a first embodiment.

FIG. 2 is a schematic plan view showing an interdigital electrode according to the first embodiment.

As shown in FIGS. 1 and 2, the liquid crystal display cell of the first embodiment includes a liquid crystal layer 30 sandwiched between a pair of substrates, namely, an array substrate 10 and a counter substrate 20. The array substrate 10 includes an insulating transparent substrate 15 composed of a material such as glass and furthermore includes signal electrodes 11 (signal electrodes), common electrodes 12, wiring lines, and TFTs formed on the transparent substrate 15. The counter substrate 20 is a blank glass substrate in the liquid crystal display cell of the first embodiment, but may be a color filter substrate including an insulating transparent substrate 25 composed of a material such as glass and a color filter and a black matrix formed on the transparent substrate 25. Furthermore, the counter substrate 20 may optionally include a common electrode and the like. For example, in the case of an IPS mode in the first embodiment, a pair of interdigital electrodes 13 (signal electrode 11 and common electrode 12) are formed only on the array substrate 10 as shown in FIG. 1, but the present invention can be applied to other modes. In such a case, if necessary, the electrodes are formed on both the array substrate 10 and counter substrate 20.

The array substrate 10 includes an alignment film (horizontal photo-alignment film) 16 and the counter substrate 20 also includes an alignment film (horizontal photo-alignment film) 26. The alignment films 16 and 26 are films mainly composed of polyimide, polyamide, polyvinyl, polysiloxane, or the like. By forming these alignment films, liquid crystal molecules can be aligned in a particular direction.

Before the PS polymerization process, a polymerizable monomer is present in the liquid crystal layer 30. The polymerizable monomer is polymerized in the PS polymerization process to form PS layers 17 and 27 on the alignment films 16 and 26, respectively, as shown in FIG. 1. The PS layers 17 and 27 increase the alignment regulating forces of the alignment films 16 and 26, respectively.

The PS layers 17 and 27 can be formed by injecting a liquid crystal composition containing a liquid crystal material and the polymerizable monomer between the array substrate 10 and the counter substrate 20 and irradiating the liquid crystal layer 30 with a certain amount of light or heating the liquid crystal layer 30 to polymerize the polymerizable monomer. Herein, PS layers 17 and 27 each having a shape that extends along the initial tilt of the liquid crystal molecules are formed by performing the polymerization while applying a voltage higher than or equal to the threshold voltage to the liquid crystal layer 30. Thus, PS layers 17 and 27 having higher alignment stability can be provided. The liquid crystal composition may optionally contain a polymerization initiator.

In a liquid crystal display panel according to the first embodiment, the array substrate 10, the liquid crystal layer 30, and the counter substrate 20 are stacked in that order in a direction from the back surface toward the viewing screen of a liquid crystal display apparatus. Linear polarizing plates 18 and 28 are disposed on the back surface side of the array substrate 10 and the viewing screen side of the counter substrate 20, respectively. A phase plate may be further disposed on each of the linear polarizing plates 18 and 28 to constitute a circular polarizing plate.

The liquid crystal display panel according to the first embodiment may be in the form of a color filter on array in which a color filter is formed on the array substrate 10. The liquid crystal display panel according to the first embodiment may employ a monochrome display system or a field sequential color system. In such a case, the color filter is not necessarily disposed.

The liquid crystal layer 30 is filled with a liquid crystal material having a characteristic of aligning in a particular direction when a constant voltage is applied. The alignment of the liquid crystal molecules in the liquid crystal layer 30 is controlled by applying a voltage higher than or equal to the threshold voltage.

The alignment film used in the first embodiment is a horizontal photo-alignment film. In the horizontal photo-alignment film, electrons at photoactive sites are excited by irradiation with light. In the case of a horizontal alignment film, since the photoactive sites directly interact with the liquid crystal layer and thus the liquid crystal is aligned, the intermolecular distance between the photoactive sites and the polymerizable monomer is shorter than that of a vertical alignment film, which remarkably increases the probability of transfer of excitation energy. In the case of the vertical alignment film, the intermolecular distance between the photoactive sites and the polymerizable monomer is long because a hydrophobic group is always present therebetween. Consequently, the energy transfer does not readily occur. Therefore, the PS process is particularly suitable for the horizontal alignment film.

An example in which a liquid crystal cell included in the liquid crystal display apparatus according to the first embodiment was actually produced will be shown below.

A glass substrate 15 having a surface on which a pair of interdigital electrodes 13 were arranged and a blank glass substrate 25 serving as a counter substrate were prepared. A polyvinyl cinnamate solution was applied onto each of the substrates by spin coating. As shown in FIG. 2, the pair of interdigital electrodes 13 includes a signal electrode 11 and a common electrode 12 that extend substantially in parallel and are each formed in a zigzag pattern. Thus, an electric field vector in the application of an electric field is substantially perpendicular to the length direction of the electrodes and a multi-domain structure is formed, which can provide good viewing angle characteristics. A double-pointed arrow in FIG. 2 indicates an irradiation polarization direction (the case where negative-type liquid crystal molecules are used). The interdigital electrodes were composed of indium zinc oxide (IZO). The width L of the interdigital electrodes was 3 μm and the distance S between the interdigital electrodes was 9 μm. The polyvinyl cinnamate solution was prepared by dissolving polyvinyl cinnamate in a solvent prepared by mixing N-methyl-2-pyrrolidone and ethylene glycol monobutyl ether in equal proportions so that the amount of the polyvinyl cinnamate was 3% by weight relative to 100% by weight of the solution. The solution was applied by spin coating, preliminarily dried at 90° C. for one minute, and then fired at 200° C. for 60 minutes while being purged with nitrogen. The fired alignment film had a thickness of 100 nm.

A liquid crystal alignment treatment was performed by irradiating these substrates with linearly polarized ultraviolet light having a wavelength of 313 nm at 5 J/cm² in the direction of the normal to the substrates. A thermosetting seal (HC1413FP: manufactured by Mitsui Chemicals, Inc.) was printed, using a screen plate, on the glass substrate 15 having a surface on which the interdigital electrodes composed of IZO were arranged. Furthermore, plastic beads (SP-2035: manufactured by SEKISUI CHEMICAL CO., LTD.) having a diameter of 3.5 μm were scattered on the blank glass substrate 25 serving as a counter substrate so that the liquid crystal layer 30 had a thickness of 3.5 μm. These two types of substrates were bonded to each other so that the directions of polarization of the applied ultraviolet light matched. Subsequently, the bonded substrates were heated at 100° C. for 60 minutes in a furnace purged with nitrogen while applying a pressure of 0.5 kgf/cm² to cure the seal. Liquid crystal was injected into the thus-produced liquid crystal cell under vacuum.

In the first embodiment, a negative-type liquid crystal (liquid crystal having negative dielectric anisotropy) MLC 6883 (manufactured by Merck) was added, and biphenyl-4,4′-diyl bis(2-methylacrylate) was added as the polymerizable monomer in an amount of 1% by weight relative to the whole liquid crystal composition. The liquid crystal is not particularly limited thereto and may be a positive-type liquid crystal (liquid crystal having positive dielectric anisotropy). The polymerizable monomer is not particularly limited to the dimethacrylate.

The inlet of the liquid crystal cell through which the liquid crystal was injected was sealed with an ultraviolet curable resin (TB3026E: manufactured by ThreeBond Co., Ltd.). The wavelength of the ultraviolet light applied in the sealing process was 365 nm, and light shielding was provided to pixel portions so that the pixel portions were not affected by the ultraviolet light. Herein, in order to prevent the liquid crystal alignment from being disturbed by an external field, the electrodes were short-circuited and a charge erasing treatment was performed on the glass surface. Subsequently, in order to eliminate the flow alignment and image sticking of the liquid crystal, a realignment treatment was performed by heating the liquid crystal cell at 130° C. for 40 minutes to provide an isotropic phase. Thus, a liquid crystal cell uniaxially aligned in a direction perpendicular to the direction of polarization of the ultraviolet light applied to the alignment film was obtained. As a result of the observation with a polarizing microscope, only a small amount of thready defects was present between the beads and there was only a slight decrease in the contrast caused by light leakage.

Subsequently, in order to perform a PS treatment on the liquid crystal cell, the liquid crystal cell was irradiated with ultraviolet light at 2 J/cm² using a black light unit (FHF32BLB: manufactured by TOSHIBA CORPORATION). Thus, the radical polymerization of biphenyl-4,4′-diyl bis(2-methylacrylate) proceeds.

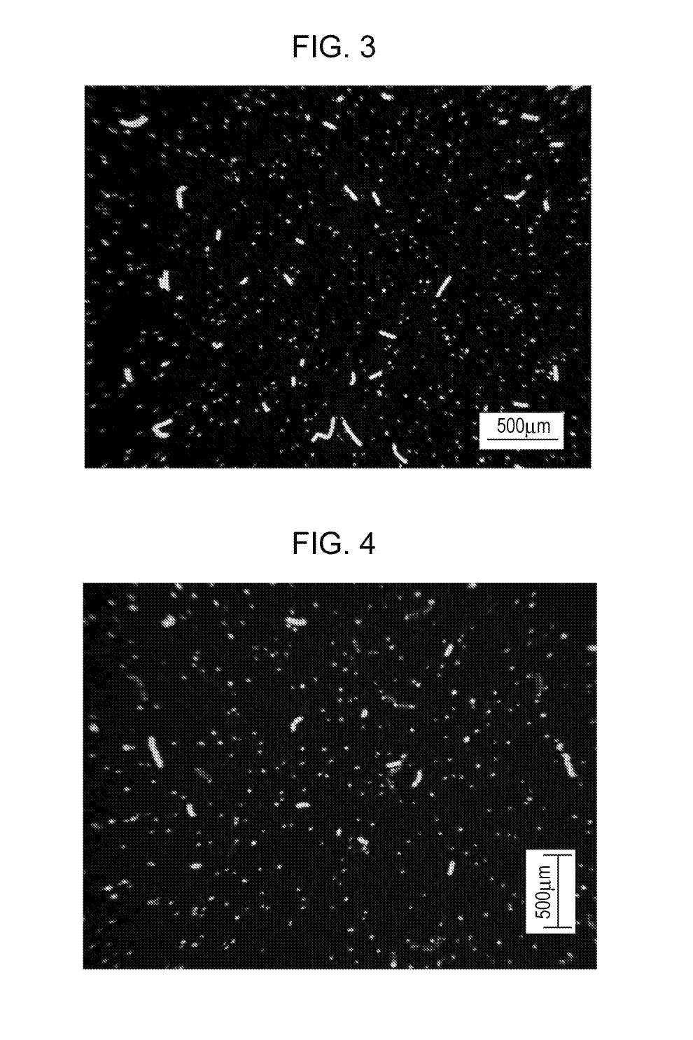

By the above method, an IPS cell (liquid crystal cell of the first embodiment) subjected to the PS treatment was produced. FIG. 3 is a photograph showing a display portion of the liquid crystal display cell according to the first embodiment. The length of each of thready defects was obviously small and the number of thready defects was also small compared with Comparative Example 1 described below.

The advantageous effects of this embodiment will be further examined. Thready defects are the alignment disturbance of liquid crystal molecules, that is, alignment defects. The reason why the light leakage occurs at the thready defects is as follows. Liquid crystal molecules are aligned in the axial direction of the polarizing plate in a region, around the thready defects, where liquid crystal molecules are uniformly aligned whereas, at the thready defects, liquid crystal molecules present on a particular line are subjected to 180-degree rotation and the axis of the liquid crystal molecules is shifted from the axial direction of the polarizing plate. In other words, the thready defects have an elastic energy generated by alignment deformation.

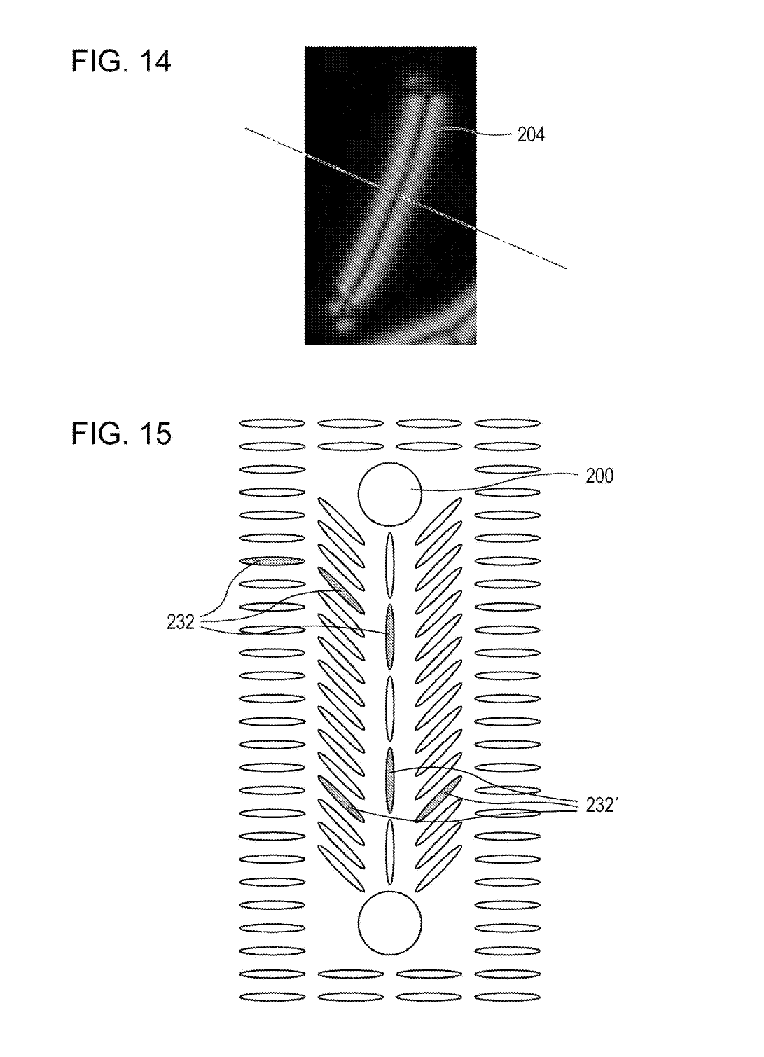

FIGS. 13 and 14 are photographs showing thready defects. FIG. 15 shows an example of the alignment state of liquid crystal molecules in a region where thready defects occur. As shown in FIG. 13, a thready defect 204 occurs between spacers such as beads 200. As a result of the observation of liquid crystal molecules in a direction perpendicular to the longitudinal direction of the thready defect 204 with a polarizing microscope, the thready defect 204 has been found to be “a n inversion wall” in which liquid crystal molecules are subjected to 180-degree rotation. FIG. 15 shows an example of this alignment state. At the inversion wall, bend deformation and splay deformation occur. At the center of disclination (near beads 200), which is the terminal of the inversion wall, splay deformation mainly occurs. FIG. 15 shows liquid crystal molecules 232 subjected to bend deformation and liquid crystal molecules 232′ subjected to splay deformation. For example, liquid crystal molecules are subjected to 180-degree rotation on an alternate long and short dashed line (a direction perpendicular to the longitudinal direction of the thready defect 204) of FIG. 14.

The elastic energy density F of liquid crystal molecules is generally represented by formula (I) below.

F=½{K1(∇·n)̂2+K2(n·(∇×n))̂2+K3(n×(∇×n))̂2} (1)

K1 is a constant concerning splay deformation, K2 is a constant concerning twist deformation, and K3 is a constant concerning bend deformation. The above constants are each also referred to as an elastic constant. A liquid crystal having smaller constants K1 to K3 has a smaller elastic energy of alignment deformation and thus is easily subjected to alignment deformation. The thready defects, which are a problem of the present invention, are believed to be mainly caused by bend deformation and splay deformation in terms of structure. The energy of the thready defects is believed to be dependent on at least one of K1 and K3.

The elastic constants of MLC6883, which is a liquid crystal used in the first embodiment, are K1=13.1 pN and K3=13.5 pN (P. J. M. Vanbrabant et al., Journal of Applied Physics 108, 083104 (2010)). Since the liquid crystal has a large elastic constant, the energy required to form thready defects is believed to be large, which may decrease the amount of thready defects.

A liquid crystal display panel including the above-described liquid crystal cell of the first embodiment can suitably include a member (e.g., a color filter) included in typical liquid crystal display panels. A liquid crystal display apparatus including the above-described liquid crystal display panel of the first embodiment can suitably further include a member (e.g., a light source such as a backlight unit) included in typical liquid crystal display apparatuses. The liquid crystal display apparatus of the first embodiment can be appropriately used for TV panels, digital signage, monitors for medical use, electronic books, PC monitors, mobile terminal monitors, and the like. This applies to liquid crystal cells and liquid crystal display panels according to the embodiments described below.

The liquid crystal display apparatus according to the first embodiment may be a transmission type liquid crystal display apparatus, a reflection type liquid crystal display apparatus, or a reflection-transmission type liquid crystal display apparatus. When the liquid crystal display apparatus of the first embodiment is a transmission type or reflection-transmission type liquid crystal display apparatus, the liquid crystal display apparatus includes a backlight unit. The backlight unit is disposed on the back surface side of the liquid crystal cell so that light is transmitted through the array substrate 10, the liquid crystal layer 30, and the counter substrate 20 in that order. When the liquid crystal display apparatus is a reflection type or reflection-transmission type liquid crystal display apparatus, the array substrate 10 includes a reflector for reflecting outside light. In at least a region where reflection light is used for display, the polarizing plate of the counter substrate 20 needs to be a circular polarizing plate.

The liquid crystal display apparatus according to the first embodiment is disassembled and the collected liquid crystal is sealed in a cell. Thus, the elastic constant can be measured with Model EC-1 manufactured by TOYO Corporation. The measurement temperature is 20° C. The components of the horizontal photo-alignment film and the components of the polymer layer can be analyzed through chemical analysis that uses, for example, gas chromatograph mass spectrometry (GC-MS) or time-of-flight mass spectrometry (TOF-SIMS).

Furthermore, the sectional shape of the liquid crystal cell including the alignment film and PS layer can be checked by microscopic observation that uses, for example, a scanning transmission electron microscope (STEM) or a scanning electron microscope (SEM).

### Second Embodiment

A liquid crystal cell was produced in the same manner as in the first embodiment, except that a negative-type liquid crystal MLC6610 (manufactured by Merck) was used instead of the negative-type liquid crystal MLC6883 (manufactured by Merck). The polymerizable monomer was also added in the same manner.

The elastic constants of MLC6610, which is a liquid crystal used in the second embodiment, are K1=14.6 pN and K3=16.5 pN (P. J. M. Vanbrabant et al., Journal of Applied Physics 108, 083104 (2010)). Since the elastic constant is larger than that of 5CB, which is a liquid crystal used in Comparative Example 1 described below, the energy required to form thready defects is believed to be large.

Consequently, the amount of thready defects may be decreased.

FIG. 4 is a photograph showing a display portion of the liquid crystal display cell according to the second embodiment. The length of each of thready defects was obviously small and the number of thready defects was also small compared with Comparative Example 1 described below.

### Third Embodiment

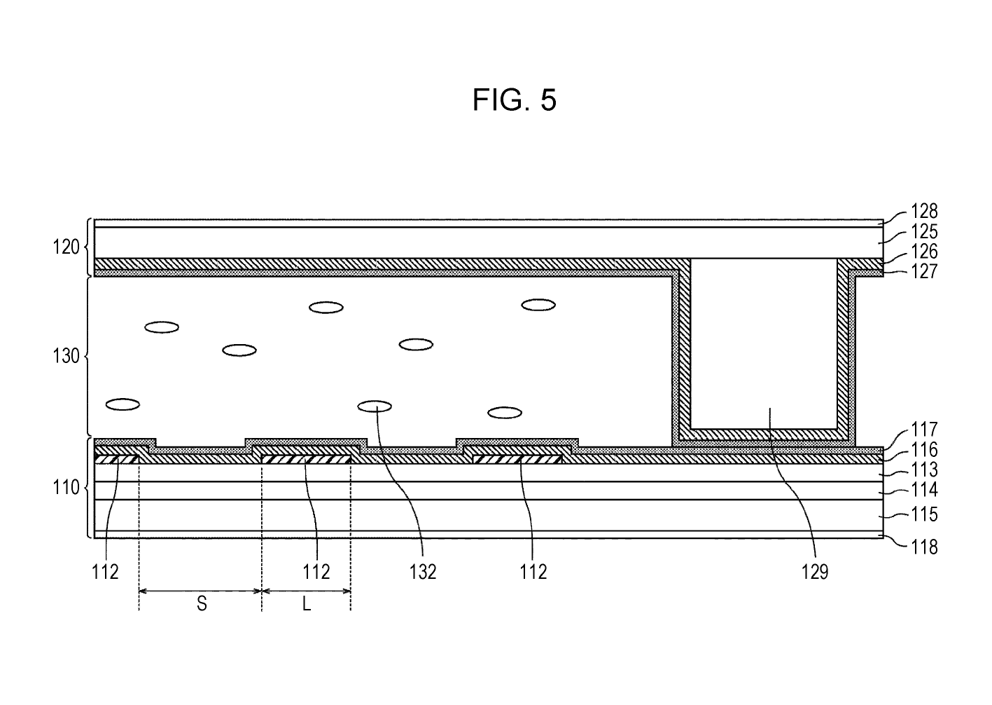

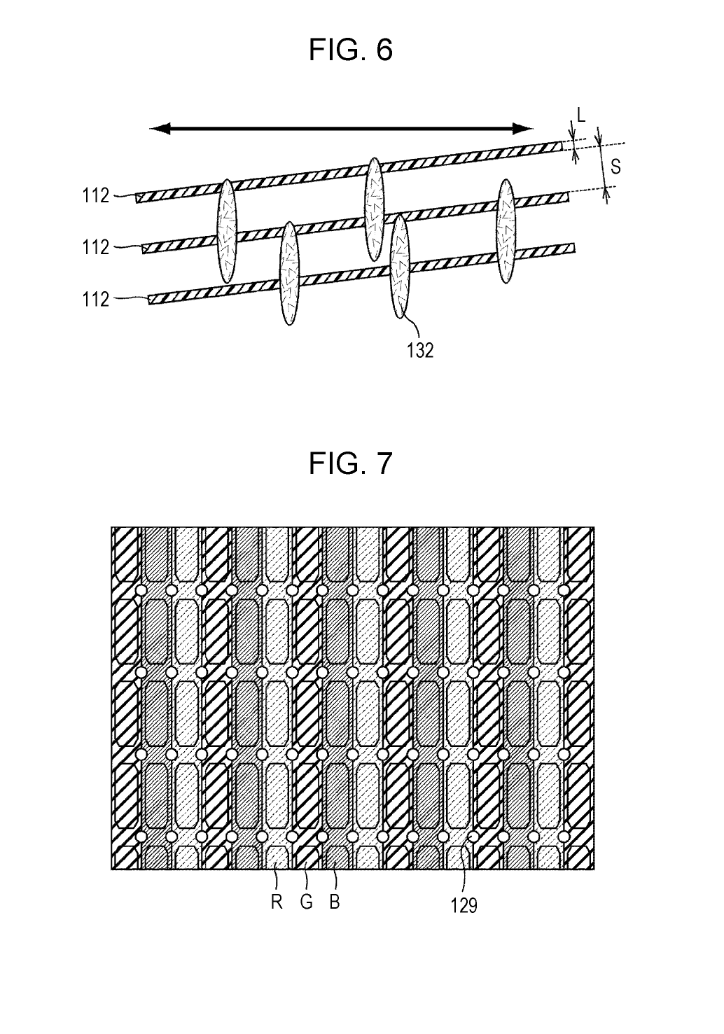

FIG. 5 is a schematic sectional view showing a liquid crystal display panel according to a third embodiment. FIG. 6 is a schematic plan view showing an electrode having slits according to the third embodiment. FIG. 7 is a schematic plan view showing a counter substrate according to the third embodiment. In FIGS. 5 to 7 according to the third embodiment, members and portions having the same functions as those shown in FIGS. 1 and 2 according to the first embodiment are designated by the same reference signs except that 1 is added to hundreds column unless otherwise specified.

In Examples 1 and 2 and Comparative Example 1 described below, a glass substrate (L/S=3 μm/9 μm) having interdigital electrodes composed of IZO and a counter substrate composed of blank glass were used. In this embodiment, a thin film transistor (TFT) substrate having a fringe field switching (FFS) structure and a CF substrate serving as a counter substrate and having spacers 129 were used. The spacers were each made of an acrylic resin in this embodiment, but the material is not particularly limited as long as a desired thickness of the liquid crystal cell is maintained by the spacers 129. The spacers 129 were arranged on a black matrix (BM) at intervals of 60 μm in a transverse direction and 160 μm in a longitudinal direction and were not able to be observed with transmitted light (the spacers were observed with reflected light in FIG. 7). The TFT substrate includes an electrode 112 having slits in an upper layer and a lower-layer electrode 114 in a lower layer. An insulating layer 113 is disposed between the electrode 112 having slits and the lower-layer electrode 114. In slit portions of the electrode 112 having slits, as shown in FIG. 6, a plurality of electrodes extend substantially in parallel and each of the slit portions is formed in a straight line. In FIG. 6, the direction of the polarization of the applied ultraviolet light is tilted 7° with respect to the longitudinal direction of the electrode. In general, the electrode 112 having slits in the upper layer serves as a signal electrode and the lower-layer electrode 114 serves as a common electrode. The electrode in the upper layer may be, for example, a pair of interdigital electrodes instead of the electrode having slits. A double-pointed arrow in FIG. 6 indicates an irradiation polarization direction (the case where negative-type liquid crystal molecules are used) as in FIG. 2. The electrodes were composed of indium tin oxide (ITO). In the electrode having slits in the upper layer, the electrode width L was set to be 5 μm and the electrode distance S was set to be 5 μm. Furthermore, MLC6883 (manufactured by Merck) was used as the liquid crystal. The elastic constant of MLC6883 has been described in the first embodiment. Since the liquid crystal has a large elastic constant, the energy required to form thready defects is believed to be large, which may decrease the amount of thready defects. Other structures (e.g., other members and processes for producing the liquid crystal display panel, such as a PS layer obtained by a PS treatment) are the same as those of the second embodiment. The polymerizable monomer was also added in the same manner.

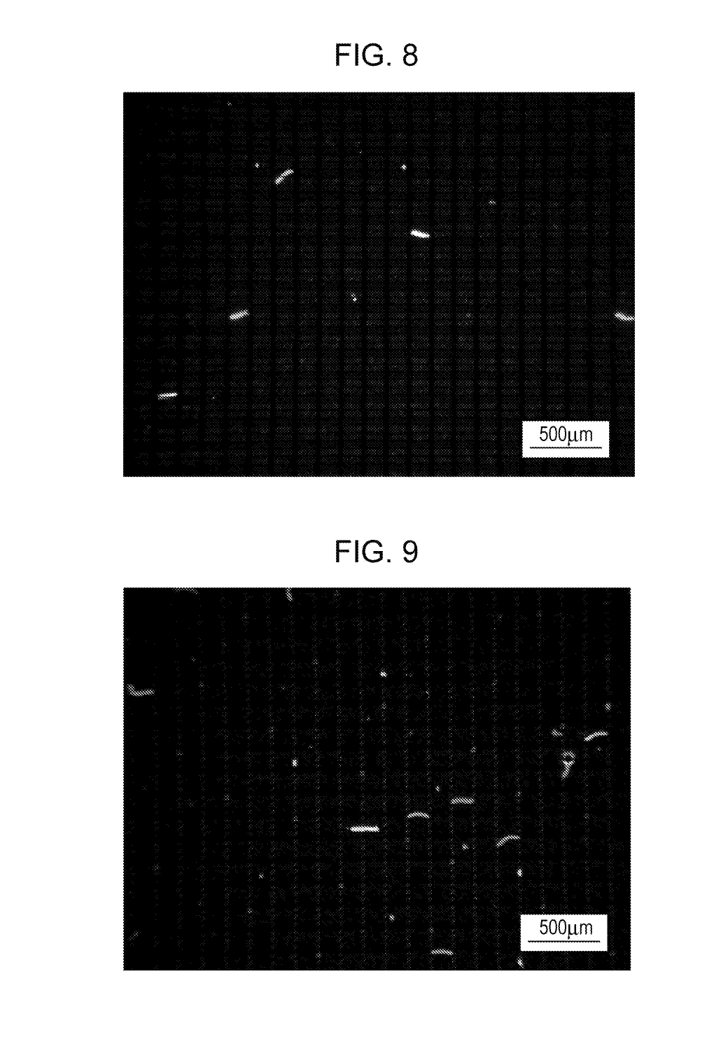

FIG. 8 is a photograph showing a display portion of the liquid crystal display panel according to the third embodiment. The length and number of thready defects were favorably decreased compared with Comparative Example 2 described below.

### Fourth Embodiment

An FFS mode liquid crystal display panel was produced in the same manner as in the third embodiment, except that a negative-type liquid crystal MLC6610 (manufactured by Merck) was used. The polymerizable monomer was also added in the same manner. The elastic constant of MLC6610 has been described in the second embodiment. Since the liquid crystal has a large elastic constant, the energy required to form thready defects is believed to be large, which may decrease the amount of thready defects. Other structures (e.g., other members and processes for producing the liquid crystal display panel, such as an FFS mode electrode structure and a PS layer obtained by a PS treatment) are the same as those of the third embodiment.

FIG. 9 is a photograph showing a display portion of the liquid crystal display panel according to the fourth embodiment. The length and number of thready defects were favorably decreased compared with Comparative Example 2 described below.

### Fifth Embodiment

An FFS mode liquid crystal display panel was produced in the same manner as in the third embodiment, except that a negative-type liquid crystal MLC6608 (manufactured by Merck) was used. The polymerizable monomer was also added in the same manner. The elastic constants of MLC6608 are K1=16.7 pN and K3=18.1 pN (P. J. M. Vanbrabant et al., Journal of Applied Physics 108, 083104 (2010)). Since the liquid crystal has a large elastic constant, the energy required to form thready defects is believed to be large, which may decrease the amount of thready defects. Other structures (e.g., other members and processes for producing the liquid crystal display panel, such as an FFS mode electrode structure and a PS layer obtained by a PS treatment) are the same as those of the third embodiment.

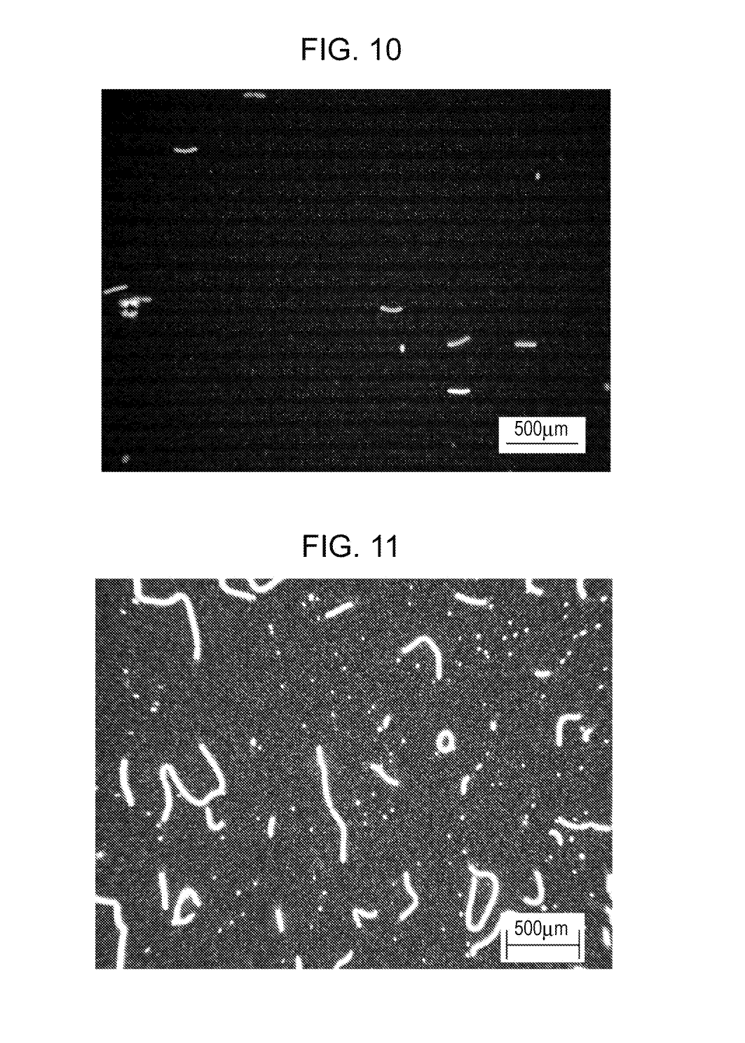

FIG. 10 is a photograph showing a display portion of the liquid crystal display panel according to the fifth embodiment. The length and number of thready defects were favorably decreased compared with Comparative Example 2 described below.

In the PS-IPS mode (IPS mode subjected to a PS treatment) liquid crystal display apparatuses described in the first and second embodiments and the PS-FFS mode (FFS mode subjected to a PS treatment) liquid crystal display apparatuses described in the third to fifth embodiments, liquid crystal molecules are suitably aligned by photo-alignment rather than rubbing because alignment unevenness and the generation of dust can be suppressed. However, it has been difficult to mass-produce a horizontal photo-alignment film because such a horizontal photo-alignment film generally has a weak alignment regulating force and therefore causes severe image sticking (the horizontal photo-alignment film serves as the above-described horizontal alignment film and photo-alignment film; aligns liquid crystal molecules substantially horizontally with respect to the substrate; has a functional group in the molecule of the alignment film, the functional group causing photoisomerization, photodimerization, or photolysis through irradiation with light; and can align liquid crystal molecules through polarized irradiation). The inventors of the present invention have overcome the difficulties by performing a polymer sustained (PS) treatment. However, in particular, the horizontal photo-alignment film causes thready defects because of its weak alignment regulating force. The inventors of the present invention have successfully overcome the problem by selecting a liquid crystal.

In the case where the liquid crystal display apparatus is actually used in an environment exposed to visible light (e.g., liquid crystal TV), visible light should be avoided as light used for an alignment treatment of a horizontal photo-alignment film as much as possible. However, the liquid crystal display apparatuses according to the first to third embodiments have an advantage in that the horizontal photo-alignment film may be composed of a material that has a sensitive wavelength within a visible light region. This is because the surface of the alignment film is covered with a PS layer by performing a PS treatment and thus the alignment is fixed.

Furthermore, in consideration of the fact that, when the horizontal photo-alignment film is composed of a material that has a sensitive wavelength within an ultraviolet region, an ultraviolet absorbing layer needs to be disposed in order to block weak ultraviolet light emitted from a back light unit and an ambient environment, there is also an advantage in that such an ultraviolet absorbing layer need not be disposed by the PS process.

When the PS treatment is performed using ultraviolet light, the ultraviolet light may reduce the voltage holding ratio (VHR) because liquid crystal is irradiated with ultraviolet light. However, the ultraviolet light irradiation time can be shortened by efficiently performing the PS process as in Examples 1 to 3, and thus such a reduction in the voltage holding ratio is avoided.

In addition, the image sticking is suppressed and therefore the PS irradiation dose (time) can be decreased. In the production of liquid crystal display panels, the throughput is increased by decreasing the irradiation dose (time). The irradiation equipment can be downsized, which decreases the investment cost.

The irradiation with linearly polarized ultraviolet light of the photo-alignment treatment in Examples 1 to 5 is performed before the pair of substrates are bonded to each other. However, the photo-alignment treatment may be performed from the outside of the liquid crystal cell after the pair of substrates are bonded to each other. The photo-alignment treatment may be performed before or after liquid crystal is injected. In the case where the irradiation with linearly polarized ultraviolet light of the photo-alignment treatment is performed after liquid crystal is injected, the photo-alignment treatment and a PS process can be simultaneously performed, which can reduce the number of processes.

### Sixth Embodiment

An FFS mode liquid crystal display panel was produced in the same manner as in the third embodiment, except that trans-4-propyl-4′-vinyl-1,1′-bicyclohexane, which is a liquid crystal molecule having an alkenyl group, was further added to the negative-type liquid crystal MLC6608 (manufactured by Merck). Furthermore, biphenyl-4,4′-diyl bis(2-methylacrylate), which is a polymerizable monomer, was also added. The mixing ratio by weight was MLC6608:trans-4-propyl-4′-vinyl-1,1′-bicyclohexane:biphenyl-4,4′-diyl bis(2-methylacrylate)=100:5:0.3. Other structures (e.g., other members and processes for producing the liquid crystal display panel, such as an FFS mode electrode structure and a PS layer obtained by a PS treatment) are the same as those of the third embodiment.

As a result of the observation of the produced panel with a polarizing microscope, the length and number of thready defects were favorably decreased compared with Comparative Example 2 described below.

The liquid crystal panel of the sixth embodiment was evaluated for image sticking. The evaluation of image sticking was performed by the following method. A region X and a region Y in which two different voltages can be applied were formed in the liquid crystal panel of the sixth embodiment. A voltage of 6 V was applied between the electrode having slits (source electrode) and the lower-layer electrode (common electrode) for 6 hours in the region X while at the same time no voltage was applied in the region Y. Subsequently, a voltage of 2.4 V was applied in the region X and the region Y, and the luminance T(x) in the region X and the luminance T(y) in the region Y were measured. The luminance was measured using a digital camera (EOS Kiss Digital N EF-S18-55II U: manufactured by Canon Inc.). A value of ΔT(x,y) (%), which is an index of image sticking, was calculated from the following formula.

ΔT(x,y)=(|T(x)−T(y)|/T(y))×100

The image sticking ratio ΔT of the liquid crystal panel of the sixth embodiment was as small as 10%, which was a considerably good result.
This may be because the polymer layer produces an effect of suppressing image sticking and also the liquid crystal molecule having an alkenyl group facilitates the formation of the polymer layer.

An FFS mode is superior to an IPS mode in terms of transmittance and thus has an advantage in that a high-resolution panel with low power consumption can be produced. Since higher resolution has been remarkably required for panels for mobile terminals (tablet terminals and smart phones) in recent years, the number density of photo spacers increases and thready defects readily occur in FFS mode liquid crystal display apparatuses produced by employing photo-alignment. Therefore, the present invention can be suitably applied. The structure of FFS mode liquid crystal display apparatuses is different from the structure of IPS mode liquid crystal display apparatuses in that a lower-layer electrode is present. Such a structure has a shielding effect against static electricity. Thus, the image sticking of liquid crystal alignment and the breakdown of transistors caused by static electricity can be prevented, which increases the yield of production.

### Comparative Example 1

In Comparative Example 1, the constituent members and the cell production process were the same as those of the first embodiment, except that 4-cyano-4′-pentylbiphenyl (5CB) was used for liquid crystal. However, in Comparative Example 1, when a realignment treatment was performed in order to eliminate the flow alignment and image sticking of the liquid crystal by heating the liquid crystal cell at 130° C. for 40 minutes to provide an isotropic phase and a liquid crystal cell uniaxially aligned in a direction perpendicular to the direction of polarization of the ultraviolet light applied to the alignment film was obtained, it was observed with a polarizing microscope that thready defects were generated between beads and light leakage occurred. Furthermore, the alignment of an IPS cell produced by a PS treatment using the method of the first embodiment was observed with a polarizing microscope. The liquid crystal was uniaxially aligned even after the PS treatment like before the PS treatment, but the thready defects were also immobilized. FIG. 11 is a photograph showing a display portion of the liquid crystal display cell according to Comparative Example 1. Many thready defects including a thready defect having a length of 1000 μm were observed.

The elastic constants of 5CB are K1=7.1 pN and K3=9.8 pN (T. N. Oo et al. PHYSICAL REVIEW E 76, 031705 (2007)). Since 5CB is present in the form of a crystal phase at 20° C., for only 5CB, the elastic constants at 22° C. (crystal-liquid crystal phase transition temperature) at which 5CB is present in the form of a liquid crystal phase are shown. Herein, 5CB is not a liquid crystal molecule having a K1 and/or K3 of 13 pN or more at 20° C.

### Comparative Example 2

In Comparative Example 2, the constituent members and the production process of a liquid crystal display panel were the same as those of the third embodiment, except that 4-cyano-4′-pentylbiphenyl (5CB) was used for liquid crystal. Note that the elastic constant of 5CB has been described in Comparative Example 1. The polymerizable monomer was also added in the same manner.

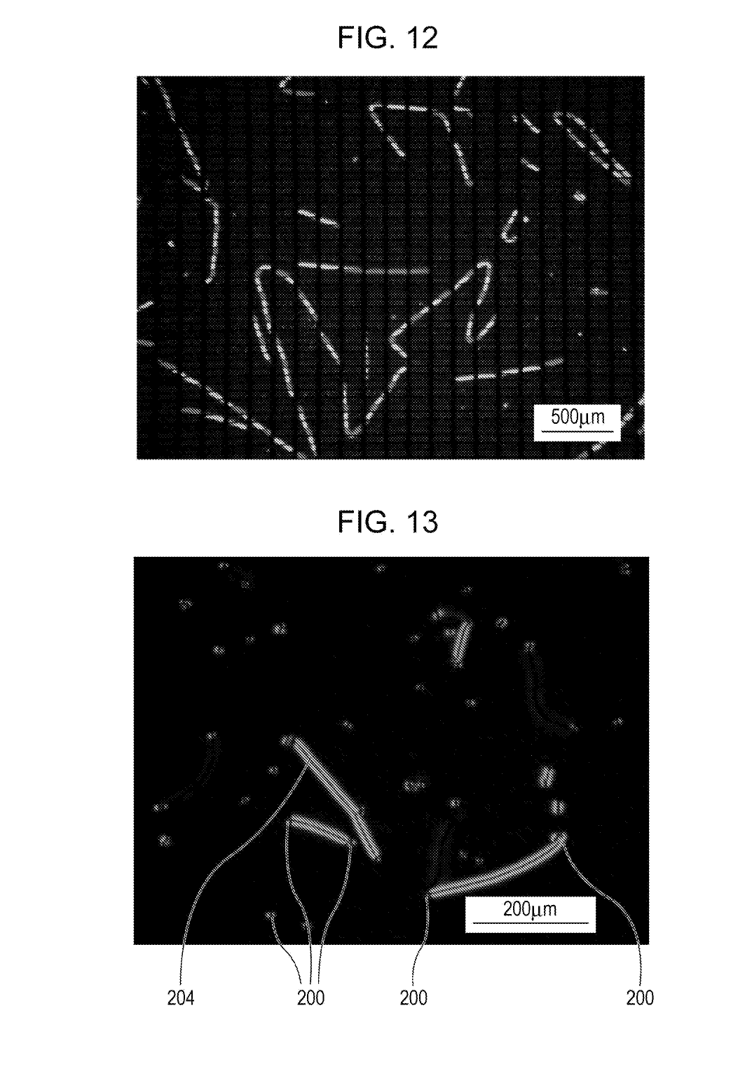

FIG. 12 is a photograph showing a display portion of the liquid crystal display panel according to Comparative Example 2. As in Comparative Example 1, there were many thready defects. In Comparative Example 2, even in a liquid crystal panel having an FFS structure, many thready defects are generated when the elastic constant of liquid crystal is small as in the liquid crystal cell according to Comparative Example 1.

### Comparative Example 3

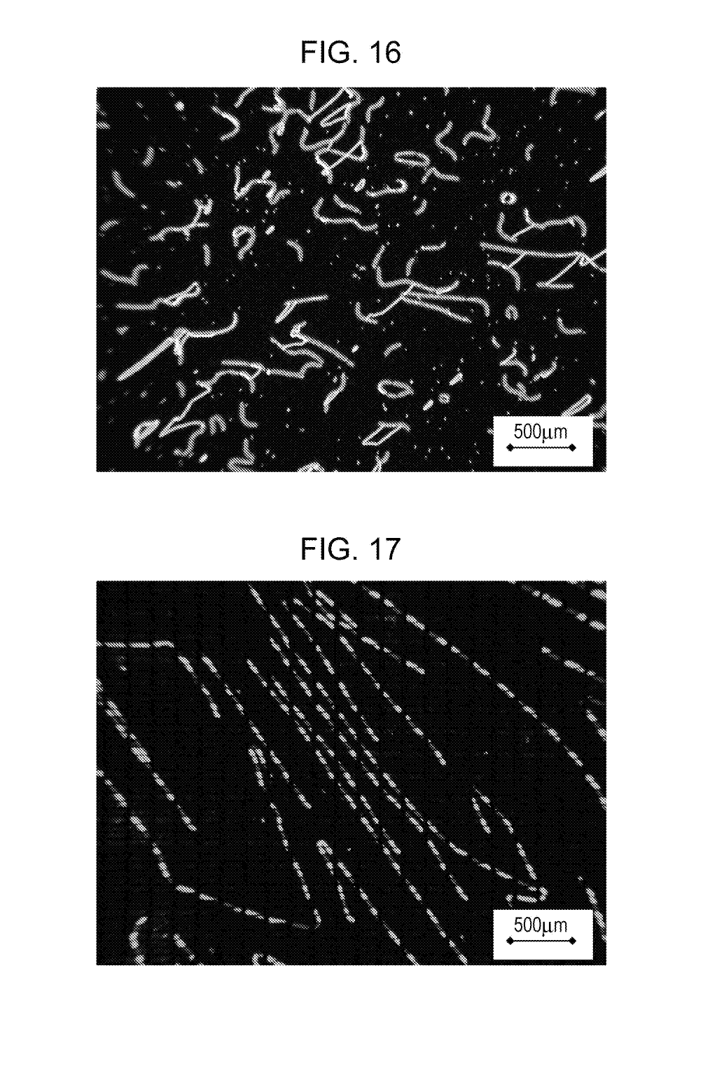

In Comparative Example 3, the constituent members and the cell production process were the same as those of Comparative Example 1, except that 4-cyano-4′-hexylbiphenyl (6CB) was used for liquid crystal. The alignment of the produced IPS cell was observed with a polarizing microscope. The liquid crystal was uniaxially aligned even after the PS treatment like before the PS treatment, but the thready defects were also immobilized. FIG. 16 is a photograph showing a display portion of the liquid crystal display cell according to Comparative Example 3. Many thready defects including a thready defect having a length of 1000 μm were observed as in Comparative Example 1.

Regarding the phase transition temperature of 6CB, the crystal phase (Cr)-nematic phase (N) transition temperature was 15° C. and the nematic phase (N)-isotropic phase (Iso) transition temperature (TnI) was 28° C. (Cr 15° C. N 28° C. Iso). The elastic constants of 6CB at 20° C. are K1=4.9 pN and K3=6.0 pN (N. V. Madhusudana et al. Mol. Cryst. Liq. Cryst., 1982, Vol. 89, pp. 249-257 (1982)).

### Comparative Example 4

In Comparative Example 4, the constituent members and the production process of a liquid crystal display panel were the same as those of the third embodiment, except that 4-cyano-4′-hexylbiphenyl (6CB) was used for liquid crystal. Note that the elastic constant of 6CB has been described in Comparative Example 3. The polymerizable monomer was also added in the same manner.

FIG. 17 is a photograph showing a display portion of the liquid crystal display panel according to Comparative Example 4. As in Comparative Example 3, there were many thready defects. In Comparative Example 4, even in a liquid crystal panel having an FFS structure, many thready defects are generated when the elastic constant of liquid crystal is small as in the liquid crystal cell according to Comparative

### Example 3

The cells and panels in the first to sixth embodiments are improved compared with those in Comparative Examples 1 to 4. It is clear from the above results that a remarkable improvement (boundary) is seen at an elastic constant of 13 pN or more.

The forms in the above-described embodiments may be combined with each other without departing from the scope of the present invention.

The present application claims priority under the Paris Convention or the domestic law in the country to be entered into national phase on Japanese Patent Application No. 2011-051532, filed on Mar. 9, 2011. The contents of this application are incorporated herein by reference in its entirety.

### REFERENCE SIGNS LIST

10: array substrate
11: signal electrode
12: common electrode
13: a pair of interdigital electrodes
15, 25, 115, 125: glass substrate
16, 26, 116, 126: alignment film (horizontal photo-alignment film)
17, 26, 116, 126: PS layer (polymer layer)
18, 28, 118, 128: linear polarizing plate
20: counter substrate
30, 130: liquid crystal layer
32, 132: liquid crystal molecule
112: electrode having slits
113: insulating layer
114: lower-layer electrode
129: spacer
200: bead
204: thready defect
232: liquid crystal molecule subjected to bend deformation
232′: liquid crystal molecule subjected to splay deformation
R: red pixel
G: green pixel
B: blue pixel

1. A liquid crystal display panel comprising a pair of substrates and a liquid crystal layer sandwiched between the pair of substrates,
wherein at least one of the pair of substrates includes a photo-alignment film and an electrode in that order from the liquid crystal layer side, and
the liquid crystal layer contains liquid crystal molecules whose elastic constant K1 concerning splay deformation and/or elastic constant K3 concerning bend deformation is 13 pN or more at 20° C.

2. The liquid crystal display panel according to claim 1, wherein the photo-alignment film is a photo-alignment film that aligns the liquid crystal molecules in a horizontal direction with respect to a main surface of the substrate.

3. The liquid crystal display panel according to claim 1, wherein the photo-alignment film contains at least one structure selected from the group consisting of a photoisomerized structure of a photo-functional group, a photodimerized structure of a photo-functional group, and a photolyzed structure of a photo-functional group.

4. The liquid crystal display panel according to claim 3, wherein the photo-alignment film is composed of a cinnamate derivative.

5. The liquid crystal display panel according to claim 1, wherein the at least one of the pair of substrates includes a polymer layer formed between the liquid crystal layer and the photo-alignment film in the liquid crystal display panel.

6. The liquid crystal display panel according to claim 5, wherein the liquid crystal layer contains liquid crystal molecules having an alkenyl group.

7. The liquid crystal display panel according to claim 5, wherein the polymer layer is formed by polymerizing a monomer having an acrylate group or a methacrylate group.

8. The liquid crystal display panel according to claim 1, wherein the elastic constants K1 and K3 are each 13 pN or more at 20° C.

9. The liquid crystal display panel according to claim 1, wherein the at least one of the pair of substrates contains a linear electrode.

10. A liquid crystal display apparatus comprising the liquid crystal display panel according to claim 1.

11. The liquid crystal display apparatus according to claim 10, wherein the liquid crystal display apparatus is an IPS mode liquid crystal display apparatus.

12. The liquid crystal display apparatus according to claim 10, wherein the liquid crystal display apparatus is an FFS mode liquid crystal display apparatus.

13. A liquid crystal display cell comprising a pair of substrates and a liquid crystal layer sandwiched between the pair of substrates, wherein at least one of the pair of substrates includes a photo-alignment film and an electrode in that order from the liquid crystal layer side, and
the liquid crystal layer contains liquid crystal molecules whose elastic constant K1 concerning splay deformation and/or elastic constant K3 concerning bend deformation is 13 pN or more at 20° C.

14. The liquid crystal display cell according to claim 13, wherein the photo-alignment film is a photo-alignment film that aligns the liquid crystal molecules in a horizontal direction with respect to a main surface of the substrate.
